(19) United States
(12) Patent Application Publication
(10) Pub. No.: US 2013/0049277 A1
(43) Pub. Date: Feb. 28, 2013

(54) POSITIONING MECHANISM

(71) Applicant: FENG-HUA NIE, Shenzhen City (CN)

(72) Inventor: FENG-HUA NIE, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/271,154

(22) Filed: Oct. 11, 2011

(30) Foreign Application Priority Data
Aug. 25, 2011 (CN) 201110245673.X

(51) Int. Cl. B23Q 3/18

(52) U.S. Cl. 269/315

(57) ABSTRACT

A position mechanism includes a base and a telescopable member. The base defines a first receiving cavity. The telescopable member includes a base portion and a protruding portion protruding from a top of the base portion. A step is formed between the base portion and the protruding portion. The base portion is received in the first receiving cavity and capable of sliding in the first receiving cavity.

### BACKGROUND

1. Technical Field

The present disclosure relates to position mechanisms.

2. Description of Related Art

During assembly, generally, a number of objects need to be accurately positioned. Although many positioning structures have been proposed and satisfy basic requirements, it is still desirable to provide a new positioning mechanism.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an assembling device with a position mechanism in accordance with an exemplary embodiment.

FIG. 2 is an enlarged view of a portion II of FIG. 1.

FIG. 3 is a schematic view of a portion of the position mechanism of FIG. 1 positioning objects in accordance with an exemplary embodiment.

FIG. 4 is a cross section view taken along an IV-IV line of FIG. 1.

### DETAILED DESCRIPTION

The disclosure is illustrated by way of example and not by way of limitation. It should be noted that references to “an” or “one” embodiment in this disclosure are not necessarily to the same embodiment, and such references mean at least one.

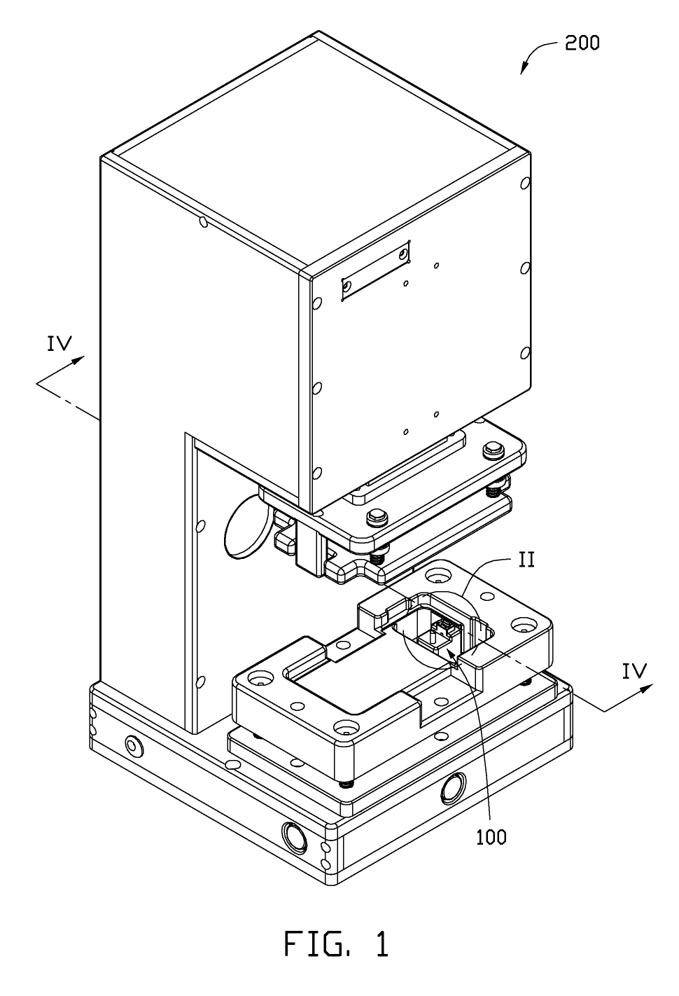

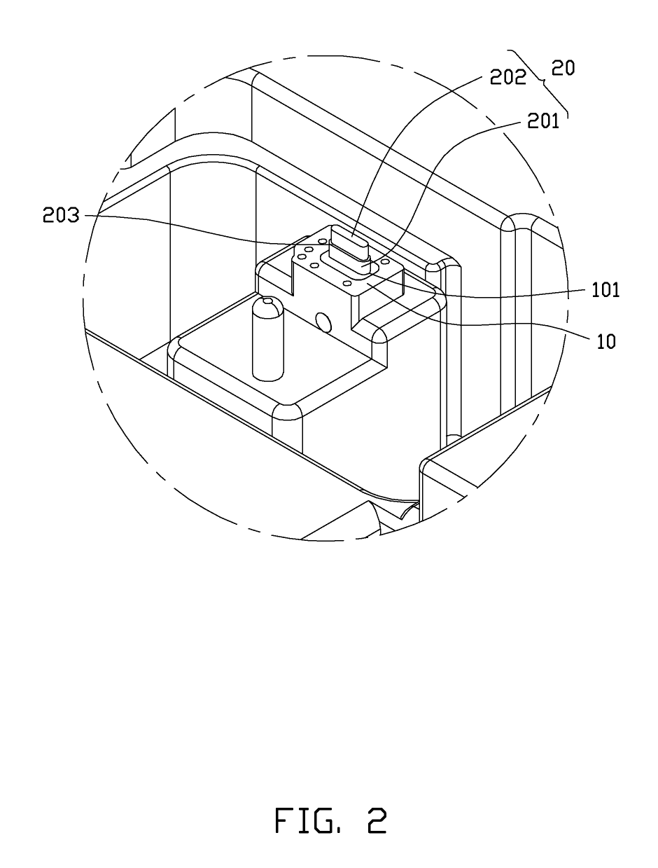

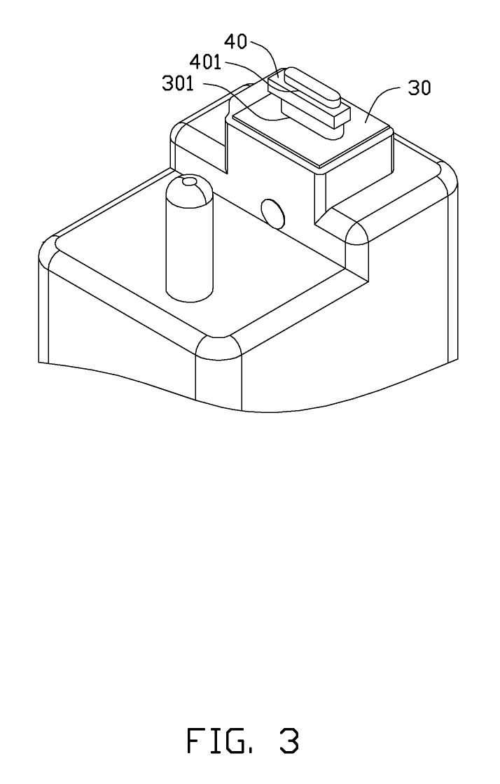

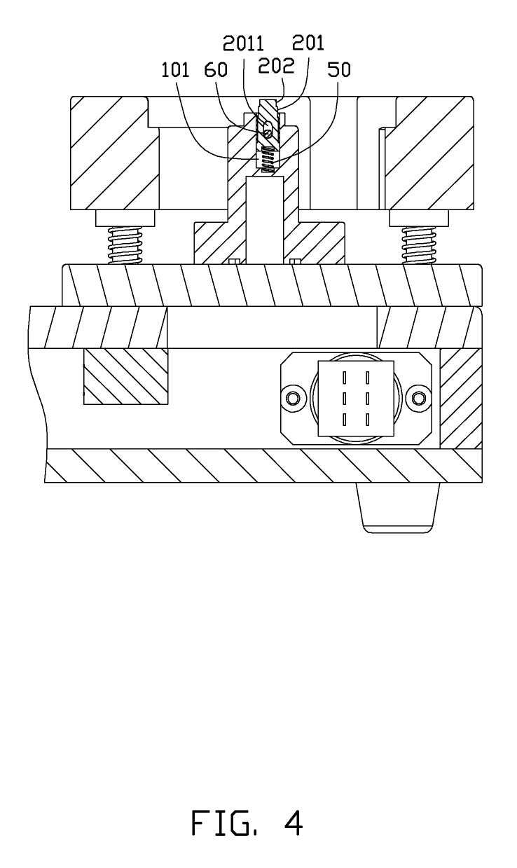

Referring to FIGS. 1-4, an assembling device 200 is used to assemble at least two objects together. A position mechanism 100 is arranged on the assembling device 200 to position the objects. The position mechanism 100 includes a base 10 and a telescopable member 20. A first receiving cavity 101 is defined in the base 10 and configured to receive the telescopable member 20. The telescopable member 20 includes a base portion 201 and a protruding portion 202 protruding from the top of the base portion 201. A transversal cross section of the base portion 201 is greater than that of the protruding portion 202, thus a step 203 is formed between the base portion 201 and the protruding portion 202. The base portion 201 is received in the first receiving cavity 101 and can slide in the first receiving cavity 101.

In this embodiment, the base portion 201 and the protruding portion 202 are integrally formed. A first through hole 301 is defined in a first object 30 to be assembled, and is sized and shaped to snugly fit around the periphery of the base portion 201. The first object 30 can then be placed on the top of the base 10 and positioned by the base portion 201 being received in the first through hole 301.

A second through hole 401 is defined in a second object 40 to be assembled, and is sized and shaped to snugly fit around the periphery of the protruding portion 202. The second object 30 can then be placed on the step 203 and positioned by the protruding portion 202 being received in the second through hole 401. For a more accurate positioning of the objects 30 and 40, the base portion 201 and the protruding portion 202 are shaped to be regular shapes. For example, the shapes of the periphery of the base portion 201 and the protruding portion 202 may be square, round, or the like.

In this embodiment, the position mechanism 100 further includes an elastic member 50. One end of the elastic member 50 is fixed to a bottom of the first receiving cavity 101, and the other end of the elastic member 50 resists against a bottom of the base portion 201. When the telescopable member 20 is pushed into the first receiving cavity 101, the elastic member 50 is urged to be elastically deformed. Once the push applied to the telescopable member 20 is released, the telescopable member 20 is returned back to an initial state under an elastic force generated by the elastic member 50. Thus, a distance between the first object 30 placed on the top of the base 10 and the second object 40 placed on the step 203 could be adjusted according to need.

The position mechanism 100 further includes a stop member 60. A slot 2011 is defined in a sidewall of the base portion 201. The slot 2011 may be a blind slot. One end of the stop member 60 is fixed to a sidewall of the first receiving cavity 101, and the other end of the stop member 60 is received in the slot 2011. Thus, the stop member 60 can stop the movement of the telescopable member 20 when contacting one end of the slot 2011. In another embodiment, the slot 2011 may be a through slot, the stop member 60 passes through the through slot 2011, and the other end of the stop member 60 is also fixed to the sidewall of the first receiving cavity 101.

It is well understood that the telescopable member 20 could include a number of protruding portions 202, and each two protruding portions 202 are connected to each other to form a step 203 between them. The shape of the periphery of each protruding portion 202 is the same as the shape of the periphery of the base portion 201, only with different sizes. The position mechanism 100 could be used to fix more objects that a through hole is defined in each object and is sized and shaped to snugly fit around the periphery of a corresponding protruding portion 202.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A position mechanism comprising:
a base defining a first receiving cavity; and
a telescopable member comprising:
a base portion; and
a protruding portion protruding from a top of the base portion, and a step being formed between the base portion and the protruding portion, wherein the base portion is received in the first receiving cavity and capable of sliding in the first receiving cavity.

2. The position mechanism as described in claim 1, wherein the base portion and the protruding portion are integrally formed.

3. The position mechanism as described in claim 1, wherein a periphery of the base portion and a periphery of the protruding portion have regular shapes.

4. The position mechanism as described in claim 1, further comprising an elastic member, wherein one end of the elastic member is fixed to a bottom of the first receiving cavity, and an opposite end of the elastic member resists against the base portion.

5. The position mechanism as described in claim 4, further comprising a stop member, wherein a slot is defined in a sidewall of the base portion, one end of the stop member is fixed to a sidewall of the first receiving cavity, and an opposite end of the stop member is received in the slot.

6. The position mechanism as described in claim 5, wherein the slot is a blind slot or a through slot.

7. The position mechanism as described in claim 4, further comprising a stop member, wherein a through slot is defined in a sidewall of the base portion, the stop member passes through the through slot and two ends of the stop member are fixed to a sidewall of the first receiving cavity respectively.
